(19) United States
(12) Patent Application Publication
(10) Pub. No.: US 2010/0012747 A1
(43) Pub. Date: Jan. 21, 2010

(54) REFILL FOR A SPRAY APPLIANCE

(75) Inventors: Nicolas Duru, Paris (FR); Michel Fontaine, Paris (FR)

Correspondence Address: OLIFF & BERRIDGE, PLC, P.O. BOX 320850, ALEXANDRIA, VA, 22320-4850, US

(73) Assignee: L'OREAL, Paris (FR)

(21) Appl. No.: 12/438,474

(22) PCT Filed: Sep. 12, 2007
(86) PCT No.: PCT/IB07/53670

§ 371 Date: Apr. 27, 2009

Related U.S. Application Data
(60) Provisional application No. 60/851,069, filed on Oct. 12, 2006.

(30) Foreign Application Priority Data
Sep. 12, 2006 (FR) 0653682

(51) Int. Cl. B05B 17/06; B05B 15/00

(52) U.S. Cl. 239/102.2; 239/326

(57) ABSTRACT

The present invention relates to a refill for a spray device for spraying at least one scented substance, the refill comprising: a reservoir of elongate shape along a longitudinal axis; and a transporter element for transporting the substance by capillarity, the element being of a shape with a bend, being in contact with the substance in the reservoir and having a dispenser end for dispensing the substance, said end being oriented transversally relative to the longitudinal axis.

The present invention relates to spray devices for spraying a scented substance, e.g. a body or room spray.

Spray devices including a piezoelectric transducer are known, in particular from U.S. Pat. Nos. 4,702,418, 5,518,179, and 6,446,880, and from US applications 2006/0146126, 2002/0070239, 2005/0185392 A1, and WO 03/037525 A1.

Some devices can receive a refill having a reservoir that contains the scented substance and a wick that is dipped in said substance and that is disposed in such a manner as to come into contact with the transducer when the refill is in place.

Above-mentioned US patent application 2002/0070239 discloses a refill that is in the form of a flexible pouch containing a porous piece that can be brought into contact with an extractor duct for taking the substance contained in the refill. The duct is secured to the spray device and opens out at one end onto the piezoelectric transducer.

Engaging the refill on the extractor duct can be awkward, thereby making it difficult to replace. In addition, passing the substance through the extractor duct delays the moment the user can start using the device once the refill has been put into place. Finally, using the device can turn out to be disconcerting to the user, because spraying is triggered by a button that is placed in the bottom corner of the casing.

European patent application EP 1 382 399 discloses a spray appliance for spraying an insecticide, the appliance including a reservoir including a wick at one end. Such an appliance is designed to function in a particular orientation, so as to keep the wick vertical for upward spraying.

Exemplary embodiments of the invention seek to make still further improvements to refills and spray devices for spraying at least one scented substance, in particular so as to enable a device that is hand-held to be easy to carry about and reliable to operate, for example.

In one of its aspects, the invention thus provides a refill for a spray device for spraying at least one scented substance, the refill comprising: a reservoir of elongate shape along a longitudinal axis; and a transport element for transporting the substance by capillarity, the element being of a shape with a bend, being in contact with the substance in the reservoir and having a dispenser end for dispensing the substance, said end being oriented transversally relative to the longitudinal axis.

In exemplary embodiments of the invention, the spray device may be made in relatively compact manner, and the refill can be put into place more easily since said refill can merely be engaged in a corresponding housing of the device, for example, with the end of the capillary transporter element being suitable for coming directly into contact with the perforated membrane of the piezoelectric transducer.

The capillary transporter may transport the substance exclusively by capillarity.

The shape with a bend, e.g. a right-angle bend, of the transporter element enables it to be immersed in the substance even when the orientation of the device changes, thereby increasing the reliability of the device and the potential uses to which it can be put.

The bend may be formed by a one-piece portion of the transporter element, or, in a variant, by assembling together at least two sub-elements that come mutually into contact inside the refill, and each of which is capable of transporting the substance by capillarity.

By way of example, the bend may enable the capillarity transporter element to open out into a front face of the refill, while extending into the proximity of the bottom of the reservoir.

The capillarity transporter element may comprise a wick.

The capillarity transporter element may already be completely impregnated with the substance when the refill is put into place in the spray device, and the substance may thus be diffused without delay.

In addition, in another aspect of the invention, and independently or in combination with the above, the spray device advantageously includes a spray-control member that is situated at its top end, so as to resemble conventional perfume bottles, and be less disconcerting to the user.

The capillarity transporter element may open out inside a recess of the refill, the recess being defined by an annular-shaped rim, for example.

The outside end of the capillarity transporter element may project from the refill, so as to make it easier to come into contact with the piezoelectric transducer, for example.

The ratio [symbol] in which L is the length of the refill and [symbol] its greatest transverse dimension, may be greater than or equal to 1.8, for example. The length L lies in the range 30 millimeters (mm) to 80 mm, the dimension [symbol] lies in the range 7 mm to 17 mm.

The working capacity may lie in the range 1 milliliter (mL) to 10 mL, and preferably lies in the range 3 mL to 5 mL.

In another of its aspects, the invention also provides a device for spraying a scented substance that is contained in a refill, e.g. as defined above, the device including a housing for receiving the refill and further including at least one piezoelectric transducer with which the capillary transporter element can come into contact when the refill is placed in the device.

The device may include a casing of elongate shape that is provided at one end with at least one spray-control member.

The device may include at least two housings and two associated piezoelectric transducers for receiving at least two refills.

The device may include a respective control member for each refill, or selector means that make it possible to select a refill prior to actuating the control member.

When the device includes a plurality of refills and relative control members associated with each refill, each control member may be situated substantially in register with its corresponding refill.

In another of its aspects, the invention also provides a spray device for spraying at least one scented substance, the spray device comprising first and second portions that are movable relative to each other, the first portion including at least one piezoelectric transducer and a housing for receiving a refill containing the scented substance, e.g. a refill as defined above.

While in a closed configuration, the second portion may cover at least one orifice through which the substance is sprayed, and while in an open configuration, it may uncover said orifice.

The second portion may include selector means for selecting a substance to be sprayed, the selector means comprising a user interface, for example, such as one or more keys, a navigator button, a cursor, a wheel, a knob, a touch-sensitive screen, a voice-control system, amongst others.

The substance is different from a medicine.

The invention can be better understood on reading the following detailed description of non-limiting embodiments thereof, and on examining the accompanying drawings, in which:

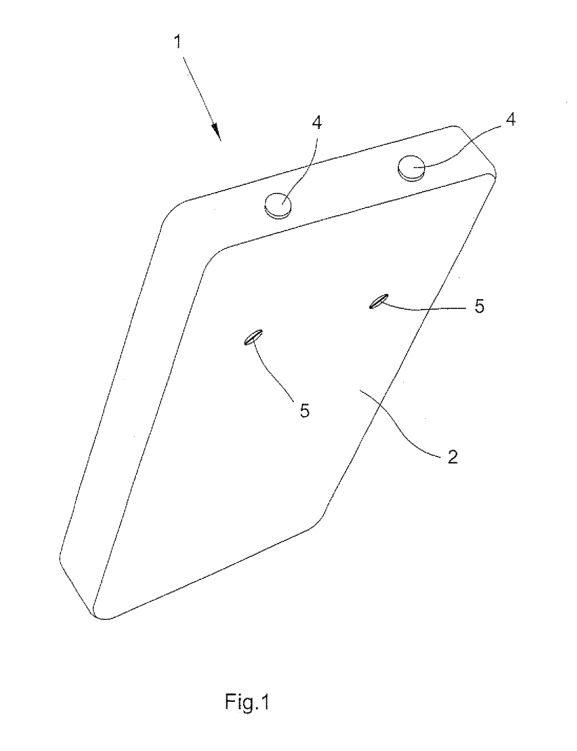

FIG. 1 is a diagrammatic perspective view of an embodiment of a spray device of the invention;

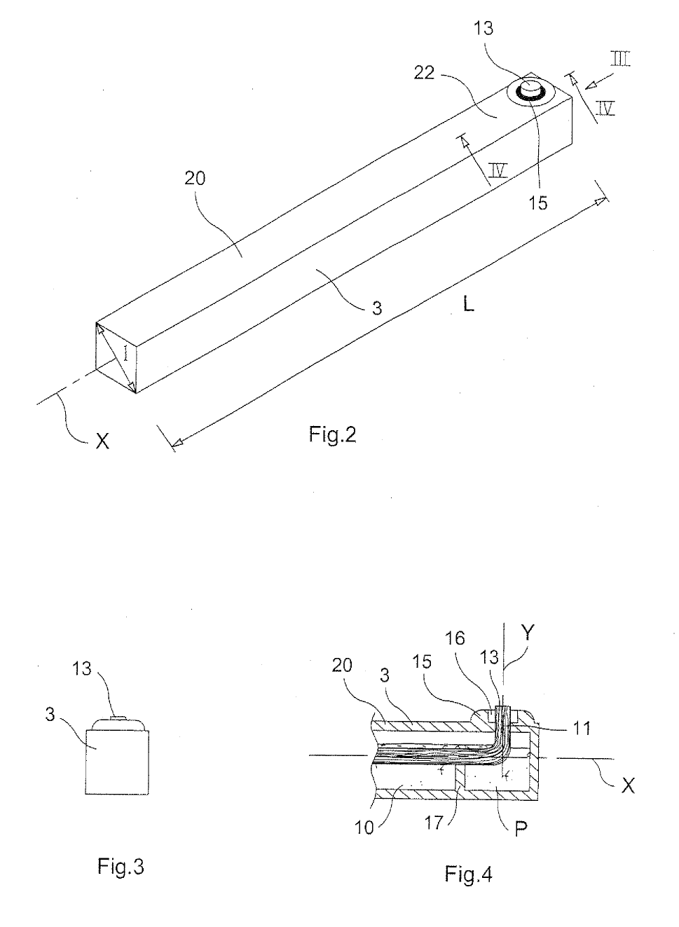

FIG. 2 is a perspective view of an embodiment of a refill;

FIG. 3 is an end view as seen looking along arrow III in FIG. 2;

FIG. 4 is a diagrammatic, fragmentary, and longitudinal section on IV-IV in FIG. 2;

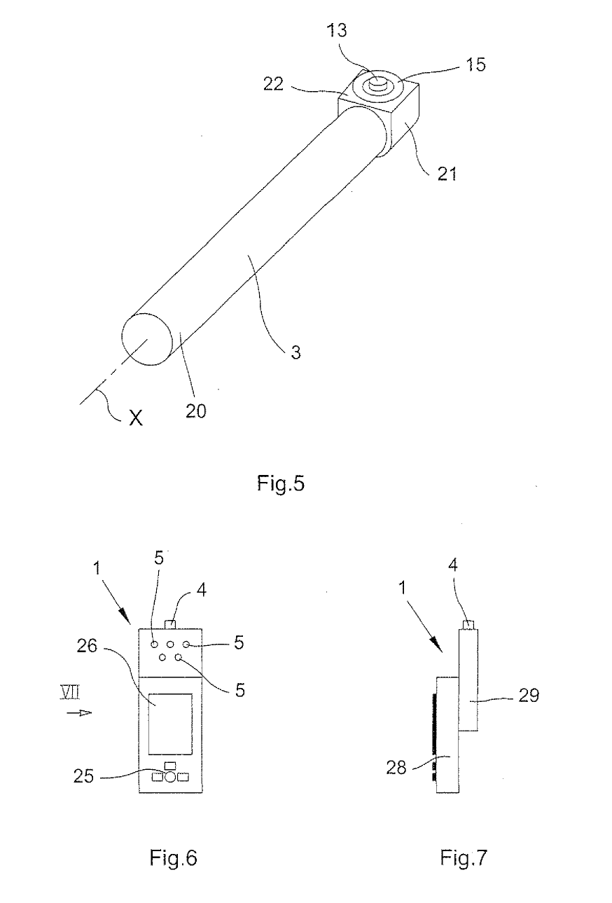

FIG. 5 is a view similar to FIG. 2 showing a variant embodiment of the refill;

FIG. 6 is an elevation view of a variant embodiment of the spray device; and

FIG. 7 is an end view as seen looking along arrow VII in FIG. 6.

The spray device 1 shown in FIG. 1 includes a casing 2 making it possible to receive one or more refills 3 such as the refill shown in FIG. 2, for example.

The device 1 includes a spray system comprising at least one piezoelectric transducer 5 and an electronic exciter circuit (not shown) for exciting the transducer.

In the embodiment shown, the device 1 receives two refills 3 containing different scented substances, for example, and includes two piezoelectric transducers 5 that are disposed side by side behind the front wall of the casing 2, and two associated control buttons 4 that are situated at the top end of the casing 2.

Each piezoelectric transducer 5 can be associated with a respective exciter circuit. In a variant, the device 1 includes a single exciter circuit for all of the transducers, and selector means making it possible to select the transducer that is to be activated.

With reference more particularly to FIGS. 2 to 4, it can be seen that the refill 3 is elongate along a longitudinal axis X and includes a body 20 defining a reservoir 10 containing the substance P to be sprayed.

The refill 3 also includes a transporter element 11 for transporting the substance P exclusively by capillarity, said element being immersed in said substance and having an end 13 that opens out to the outside of the refill.

The capillarity transporter element can comprise a wick or a duct filled with a porous material.

The element 11 need not occupy the entire volume that is available for the substance inside the refill.

In the embodiment shown, the end 13 of the element 11 projects out a little from the refill 3 on its front face 22, so as to be able to come to bear against the transducer.

An annular rim 15 extends around the end 13 and defines a recess 16.

The rim 15 makes it easier to position the end 13 relative to the transducer, and, when not in use, it also makes it possible to close, in leaktight manner, the space into which the end 13 opens out.

The rim 15 also makes it possible to receive a flexible closure film that is removed before the refill is used.

In the embodiment under consideration, the end 13 is oriented along an axis Y that extends perpendicularly to the axis X, the element 11 forming a right-angle bend inside the refill 3.

The element 11 can be held in the refill by one or more supports 17 that are integrally molded with the body 20.

The element 11 can extend over practically the entire length L of the refill 3, so as to enable the substance to reach the end 13 by capillarity, even when only a small quantity of substance remains in the reservoir 10.

The greatest transverse dimension [symbol] of the refill is selected such that the ratio [symbol] is greater than or equal to 1.8, for example.

The invention is not limited to a particular shape of refill, and, as shown in FIG. 5, said refill can include a body 20 of circular section, extended by a head 21 having a plane front face 22 into which the end 13 of the element 11 opens out.

The spray device can also be made in some other way and can include a single control member 4 that is associated with a plurality of refills, for example.

In this event, the device 1 can include selector means 25, e.g. a touch-sensitive screen or a navigator button, or any other user interface.

The device 1 can also include a hardware interface making it possible to receive, from a remote control, from a network, or from some other appliance, information that relates to the selected refill and/or that makes it possible to trigger spraying.

In the embodiment shown in FIGS. 6 and 7, the device 1 includes a screen 26 making it possible to display information relating to the selected refill, for example.

The device 1 can be made as a single unit, or, as shown in the figures, it can be in the form of at least two portions that are mutually movable, e.g. with a front portion 28 that is slidable relative to a rear portion 29.

The rear portion 29 includes the refill(s) and the associated piezoelectric transducer(s) 5, for example, whereas the front portion 28 includes the selector means 25 and the screen 26, for example, and one or more optionally-rechargeable batteries powering the electrical exciter circuit(s) for exciting the transducers, for example.

When the device 1 is in the open configuration, as shown in FIGS. 6 and 7, the spray orifices are uncovered by the front portion 28. In the closed configuration, the rear and front portions are superposed, thereby making it possible to close the spray orifices.

Naturally, the invention is not limited to the embodiments described above. In particular, features of the above-described embodiments could be combined with one another to form variants that are not shown.

The capillarity transporter element need not be a single piece.

All of the substance to be diffused could impregnate the capillarity transporter element, where appropriate.

The expression “comprising a” should be understood as being synonymous with “comprising at least one”, unless specified to the contrary.

1. A refill for a spray device for spraying at least one scented substance, the refill comprising:
a reservoir of elongate shape along a longitudinal axis; and
a transporter element for transporting the substance by capillarity, the transporter element being shaped with a bend, being in contact with the substance in the reservoir, and having a dispenser end for dispensing the substance, said dispenser end being oriented transversally relative to the longitudinal axis.

2. A refill according to claim 1, the dispenser end being oriented along an axis that is perpendicular to the longitudinal axis.

3. A refill according to claim 1, the transporter element presenting shape with a right-angle bend.

4. A refill according to claim 1, the transporter element comprising a wick.

5. A refill according to claim 1, the transporter element opening out into a front face of the refill.

6. A refill according to claim 1, the transporter element opening out inside a recess of the refill.

7. A refill according to claim 6, the recess being defined by a annular-shape rim.

8. A refill according to claim 1, the dispenser end projecting from the refill.

9. A refill according to claim 1, ratio [symbol] , in which L is the length of the refill and [symbol] the greatest transverse dimension of the refill, being greater than or equal to 1.8.

10. A device for spraying a scented substance that is contained in a refill as defined in claim 1, the device including a housing for receiving the refill.

11. A device according to claim 10, including at least one piezoelectric transducer with which the transporter element can come into contact when the refill is placed in the device.

12. A device according to claim 10, including a casing of elongate shape having at one end at least one spray-control member.

13. A device according to claim 10, including at least two housings for receiving corresponding refills and two associated piezoelectric transducers.

14. A device according to claim 13, including a respective control member for each refill.

15. A device according to claim 12, the spray-control member(s) being situated at a longitudinal end of the device,

16. A device according to claim 10, comprising two portions that are movable relative to each other, a first of said two portions including at least one piezoelectric transducer and a housing for receiving a refill containing the scented substance.

17. A device according to claim 16, the second portion being arranged, while in a closed configuration, to cover an orifice through which the scented substance is sprayed, and while in an open configuration, to uncover said orifice.

18. A device according to claim 17, the second portion including a selector for selecting the substance to be sprayed.
